(19) United States
(12) Patent Application Publication
(10) Pub. No.: US 2005/0099311 A1
(43) Pub. Date: May 12, 2005

(54) Basement flood alarm system

(76) Inventor: Tommy Eskins, Berlin Heights, OH (US)

Correspondence Address: RANKIN, HILL, PORTER & CLARK LLP, 4080 ERIE STREET, WILLOUGHBY, OH, 44094-7836, US

(21) Appl. No.: 10/983,503

(22) Filed: Nov. 8, 2004

Related U.S. Application Data
(60) Provisional application No. 60/518,113, filed on Nov. 7, 2003.

(51) Int. Cl. G08B 21/00

(52) U.S. Cl. 340/616

(57) ABSTRACT

A basement flood alarm system for use in conjunction with a basement sump pump having a crock within which water is collected includes a sound-emitting device, preferably a foghorn, that is activated whenever the water level in the crock rises above a pre-determined safe level. The level of water within the crock is detected by the use of a sensor, such as a proximity sensor or a float. Preferably the device is powered by a rechargeable battery.

### BACKGROUND OF THE INVENTION

1. Field of the Invention

The present invention relates generally to an alarm for use in conjunction with a basement sump pump and, more particularly, to a basement flood alarm system activated by rising water within the sump.

2. Description of Related Art

Basement water problems are among the most common complaints from homeowners. Water problems arise for a variety of reasons, including sewer backup, sump pump failure due to power outages or equipment failure, increased precipitation, and leaking appliances. The first time most people are aware of sump pump failure is when they enter their basements and find standing water, much to their dismay. Once the basement is flooded, the resulting damage and loss of property can cost thousands of dollars to repair or replace.

Basement sump pumps have been used for many years to remove water from the basements of buildings. Basement sump pumps generally include a crock, a pump, and a crock lid. The crock is disposed below the floor of most basements, and usually extends to a depth of two to three feet below the floor. The pump itself rests within the crock. During normal water drainage from precipitation, etc., water enters the crock and is pumped from the crock to a location away from the building. Crock lids cover the crock, thereby preventing children and animals from entering the crock, and confining moisture and mustiness within the crock. The crock lid is usually placed within the same plane as the basement floor, so as to maintain a somewhat level surface.

Several attempts have been made to alert building occupants to the existence of water problems within a basement. Certain patents disclosing these attempts will be discussed herein. The disclosures of all of such patents are fully incorporated herein by reference.

U.S. Pat. No. 4,456,432 discloses an emergency sump pump and alarm warning system. The system provides an intermittent audible alarm and an intermittent visual alarm when the auxiliary sump pump is activated. The sump pump is activated when the liquid reaches a pre-determined level, and the sump pump is deactivated when the liquid falls to another pre-determined level. The audible and visual alarms alert observers to the operation of the sump pump, and the alarms are activated by the operation of the sump pump.

U.S. Pat. No. 4,796,658 discloses an apparatus for detecting the liquid level in the basement floor drain of a building. The apparatus includes a casing that extends into the drain and a sensor that extends into the casing. The sensor is attached to control means that shut off the water supply to the building when the water level rises too high.

U.S. Pat. No. 5,314,313 provides an apparatus for monitoring a sump pump that provides a warning if the system becomes inoperative even before water enters a basement. The apparatus includes a sensor that includes two spaced leads that are each connected to an electrical circuit comprising an audible warning device. The warning device sounds when water rises above the normal pump-activation water level.

U.S. Pat. No. 5,672,050 discloses an apparatus and method for monitoring and controlling a motor driven sump pump. The apparatus includes a pressure sensor for detecting the pressure that results from the liquid level within the sump. The sensor cooperates with a control that turns the pump motor on and off when the detected pressure reaches pre-determined pressure levels. An alarm is connected to the pressure sensor, and the alarm is activated when the pressure is above a preselected pressure, indicating a water problem. A power failure or a fault condition within the pump can also trigger the pump. The alarm is an audible alarm that also includes light indicators.

U.S. Pat. No. 6,139,281 provides a sump pump alarm system that utilizes an existing alarm such as the home's doorbell or smoke alarm system to alert occupants of sump pump failure. The alarm system can be attached to existing sump pumps. Either an RF transmitter or hard wires can be used to transmit the signal to the existing alarm. A float portion carrying a switch contact moves toward a bracket when the water level rises. When the switch contact reaches an electrical contact on the bracket, a signal is sent to a control that transmits a signal by wire or by RF.

Many of the known systems are complicated and may be incompatible with many sump pump systems. While the system disclosed in U.S. Pat. No. 6,139,281 is compatible with existing sump pump systems, the system utilizes a doorbell or smoke alarm that may confuse the building occupants. There exists a need for a simple early warning system to alert homeowners of a problem with the sump pump before basement flooding occurs. Such a warning system should be easy to install and should be compatible with most existing sump pump systems. Perhaps most importantly, the system should produce a distinctive sound to indicate that there is an impending flood in the basement.

### SUMMARY OF THE INVENTION

The present invention provides a basement flood alarm system for use in conjunction with a basement sump pump having a crock within which water is collected. The alarm system comprises a sound-emitting device, preferably a foghorn, that is activated whenever the water level in the crock rises above a pre-determined safe level. The level of water within the crock is detected by use of a sensor, such as a proximity sensor or a float, that activates the sound-emitting device.

In the preferred embodiment, the invention employs a vertically extending post to which a float is attached for movement therealong. The alarm system engages the lid of the sump pump crock, so that the post extends through the crock lid. The crock lid has top and bottom surfaces. The movable float is attached to the portion of the post that extends beneath the bottom surface of the crock lid, and the sound-emitting device is positioned at the end of the post that extends above the top surface of the crock lid. The movable float is positioned along the post approximately six to twelve inches below the crock lid. When water rises within the crock and raises the float to a pre-determined level, a switch is triggered that sends a signal to the sound-emitting device, thereby triggering the alarm and emitting a distinctive foghorn-type sound. This loud sound will alert the homeowner to the existence of a water problem in the basement.

The foregoing and other features and advantages of the invention are fully described in the specification that follows. The accompanying drawings constitute a part of the specification and illustrate an exemplary embodiment of the invention.

### BRIEF DESCRIPTION OF THE DRAWINGS

FIG. 1 is a top perspective view of a basement flood alarm system of the present invention attached to a sump pump crock lid;

FIG. 2 is a side elevation view of the basement flood alarm system of FIG. 1;

FIG. 3 is a cross-sectional view of a basement flood alarm system of FIG. 1 disposed within a sump when the water is too low to activate the alarm system; and

FIG. 4 is a view similar to FIG. 3 in which the water level has activated the alarm system.

### DETAILED DESCRIPTION OF THE PREFERRED EMBODIMENT

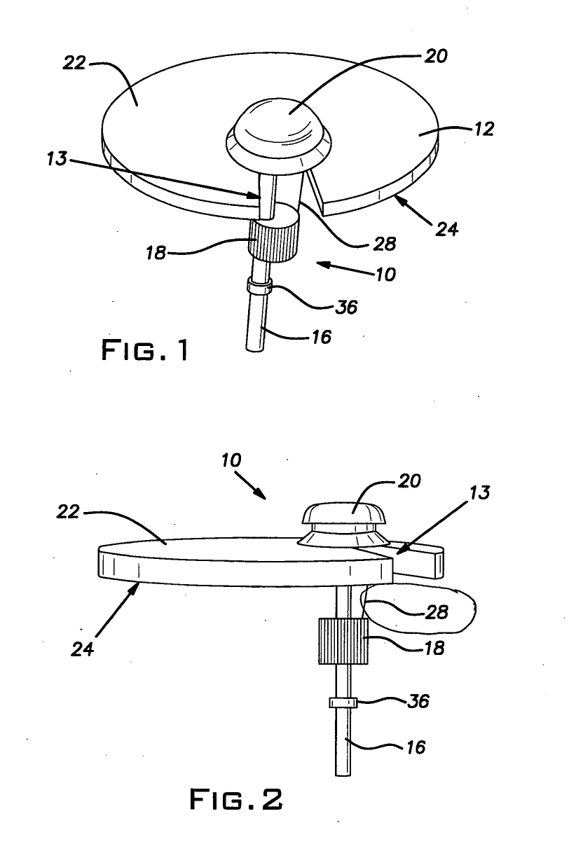

Referring to FIGS. 1-4, a basement flood alarm system according to the present invention is indicated by the reference numeral 10. The invention is described in the context of a sump pump that is used in the basement of a residential building such as a house, although it is to be understood that the sump pump could be used in any type of building and it could be used in any location where rising water might be a problem, i.e., in locations other than a basement.

The alarm system 10 is attached to a crock lid 12 of a sump pump system 14. The alarm system 10 comprises a sensor in the form of a post 16 and a movable float 18, a sound-emitting device 20, and a power source (not shown). The movable float 18 and the sound-emitting device 20 are attached to the post 16. The crock lid 12 is generally disc-shaped, and the alarm system 10 engages the crock lid 12 of the sump pump 14 so that the post 16 extends through an opening 13 in the crock lid 12. The opening 13 is illustrated in the form of a radially extending notch that opens through the periphery of the lid 12. It is to be understood that openings of other shapes and locations could be employed, if desired.

The crock lid 12 has a top surface 22 and a bottom surface 24, and the movable float 18 is attached to the portion of the post 16 that extends beneath the bottom surface 24 of the crock lid 12. The sound-emitting device 20 is positioned at the end of the post 16 that extends above the top surface 22 of the crock lid 12, so that the sound-emitting device 20 rests upon the crock lid 12. The movable float 18 is positioned at a location along the post 16 approximately six to twelve inches below the crock lid 12.

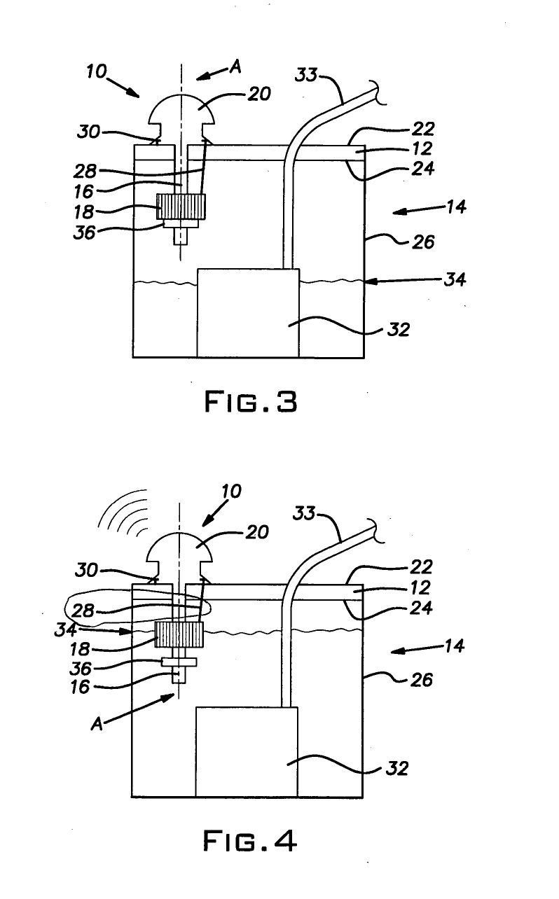

Referring particularly to FIGS. 3 and 4, the sump pump system 14 includes a crock 26, a pump 32, and a discharge conduit 33. FIG. 3 illustrates a normal water level 34 within the crock 26 that would not activate the alarm system 10 of the present invention. When water rises within the crock 26 to a water level 34 sufficient to raise the movable float 18, as shown in FIG. 4, the float will rise along with the water and the movement of the float 18 upwardly toward the crock lid 12 triggers a switch (not shown) that sends a signal to the sound-emitting device 20. The sound-emitting device 20 is activated by the signal and, upon activation, the sound-emitting device 20 emits a sound that alerts the building occupants of the potential water problem in the basement.

The post 16 extends along axis “A”, and the movable float 18 is movable along axis “A” of the post 16. When the alarm system 10 is installed in a sump pump 14, a portion of the post 16 extends into the crock 26. The portion of the post 16 that extends into the crock 26 includes a stop 36 attached to the post 16. The stop 36 engages the bottom of the movable float 18, and serves as a resting place for the movable float 18 when the water level 34 is normal, as shown in FIG. 3. The stop 36 also serves to position the movable float 18 at the desired depth within the crock 26. When the water level 34 rises, as shown in FIG. 4, the movable float 18 is carried along axis “A” toward the crock lid 12 by the water, so that the movable float 18 does not rest on the stop 36. The stop 36 may be adjustable in that it can be repositioned at different points along the post 16, and may also be affixed to the post 16 in any suitable manner. In the illustrated embodiment, the stop 36 circumscribes the post 16, but any suitable equivalent that will support the movable float 18 may be employed. The post 16 may be formed from a variety of materials, including metals and plastics, and may be made to extend to a variety of depths within the crock 26.

The movable float 18 in the illustrated embodiment is ring-shaped and circumscribes the post 16 in a manner that allows the float 18 to move along axis “A”. However, the shape of the float 18 is not critical so long as the float 18 is affixed to the post 16 so that it may move along axis “A”. The movable float 18 may be formed from any buoyant material, including foam materials and inflatable materials.

The device 10 includes a switch (not shown). While many suitable switches will be apparent to one skilled in the art, examples of suitable switches include motion sensing switches and switches that complete an electrical circuit by placing metal contacts together or transmitting current through water. When the float 18 moves along axis “A” towards the crock lid 12 and reaches a predetermined limit, the switch sends a signal to the sound-emitting device 20. In the illustrated embodiment, a lever arm 28 mechanically connects the float 18 to the switch. However, in other embodiments, a wireless system may be employed that utilizes radio or infrared signals. The switch also could be operated in other ways, such as by an electrical signal that is generated when the sensor detects that a predetermined level of water has been reached in the crock 26.

The signal causes the sound-emitting device 20 to emit sound. The sound preferably is produced in discrete blasts lasting several seconds each, and is of a volume sufficient to be heard on upper levels of the dwelling. The sound emitted by the sound-emitting device 20 may have any suitable alarm sound, although a foghorn-like sound is preferred because the occupants of a building are not likely to confuse it with a fire alarm or doorbell.

The device 10 includes a power supply (not shown). While the sound-emitting device 20 can be powered by conventional electrical power, preferably the power supply will be an electrical battery of the rechargeable type. The power supply also can be a conventional nine-volt electric battery. The use of such a battery power supply is preferred to ensure that the device 10 will operative even if electrical power to the building is lost. The sound-emitting device 20 also preferably includes electrical circuitry that will provide an alert if the battery power supply is not adequately charged.

The portion of the post 16 that extends above the top surface 22 of the crock lid 12 terminates in the sound-emitting device 20. The end of the post 16 is attached to the sound-emitting device 20 in any manner suitable to secure the sound-emitting device 20 to the post 16. Adhesives may be employed, and mechanical attachment means may also be employed, such as screw or rod attachments. In one embodiment, the end of the post 16 may be threaded and the sound-emitting device 20 may include a threaded portion adapted to receive the post 16.

In one embodiment, the alarm system 10 is affixed to the crock lid 12 using screws 30 that extend through a portion of the sound-emitting device 20 and into the top surface 22 of the crock lid 12. In other embodiments, the alarm system 10 may be attached to the crock lid 12 using any other suitable attachment means such as clips, adhesive, and the like.

Although the invention has been shown and described with respect to certain preferred embodiments, alterations to the embodiments disclosed herein may be apparent to others skilled in the art upon reading and understanding the present specification. As an example of suitable alterations (and not to delimit such possible alterations), the post 16 and float 18 could be removed and replaced by a commercially available proximity sensor, such as a capacitance-type proximity sensor, mounted within the crock 26, preferably on the bottom 24 of the lid 12. As another example of a suitable alteration, the post 16 could be removed and the float 18 could be mounted to a track included as part of, or added to, the sidewall of the crock 26. It is intended that the patent shall cover, by suitable expression in the appended claims, all such alterations as well as whatever features of patentable novelty exist in the invention disclosed.

1. A basement flood alarm system for use in conjunction with a basement sump pump in which water is collected in a crock and is removed from the crock by means of a pump, comprising:
a sensor for determining the level of water in the crock;
means for sending a signal in response to the sensor detecting that the level of water in the crock has risen to a pre-determined level in the crock; and
a sound-emitting device in the nature of a foghorn, the sound-emitting device being activated upon receiving a signal from the means for sending a signal.

2. The basement flood alarm system of claim 1, further comprising a lid disposed atop the crock.

3. The basement flood alarm system of claim 2, further comprising a post that extends into the crock, the post being connected to the lid, and wherein the sensor is in the form of a float that is carried by the post for movement therealong in response to the level of water in the crock.

4. The basement flood alarm system of claim 3, wherein the post has upper and lower ends, the upper end extends through an opening in the lid, and the sound-emitting device is connected to the upper end of the post.

5. The basement flood alarm system of claim 3, further comprising an opening in the lid through which the post extends.

6. The basement flood alarm system of claim 5, wherein the opening is in the form of a radially extending notch that opens through the periphery of the lid.

7. The basement flood alarm system of claim 1, wherein the sound-emitting device emits blasts at intervals upon activation.

8. The basement flood alarm system of claim 1, further comprising a power source for activating the sound-emitting device.

9. The basement flood alarm system of claim 8, wherein the power source is a rechargeable battery.

10. The basement flood alarm system of claim 8, wherein the power source is a battery and further comprising circuitry for activating an indicator when the battery reaches a low level of charge.

11. A basement flood alarm system for use in conjunction with a basement sump pump in which water is collected in a crock and is removed from the crock by means of a pump, comprising:
a sensor for detecting the level of water in the crock, the sensor being in the form of a vertical post that extends into the crock and a float that is movable along the post;
a switch for sending a signal in response to the float rising to a predetermined level in the crock;
a foghorn that is activated upon receiving a signal from the switch; and
a battery for activating the foghorn.

12. The basement flood alarm system of claim 11, further comprising a lid disposed atop the crock, the lid having an opening, and wherein the post has upper and lower ends, the upper end extends through the opening in the lid, and the foghorn is connected to the upper end of the post.

13. The basement flood alarm system of claim 12, wherein the opening is in the form of a radially extending notch that opens through the periphery of the lid.

14. The basement flood alarm system of claim 11, wherein the foghorn emits blasts at intervals upon activation.

15. The basement flood alarm system of claim 11, wherein the power source is a rechargeable battery.

16. The basement flood alarm system of claim 11, wherein the power source is a battery and further comprising circuitry for activating an indicator when the battery reaches a low level of charge.

17. A method for alerting occupants of a building having a sump pump with a crock for collecting water that an overflow condition is about to occur, comprising the steps of:
providing a sensor for detecting that the water in the crock has risen to a pre-determined level;
sending a signal in response to the sensor detecting that the level of water in the crock has risen to the pre-determined level;
providing a sound-emitting device in the nature of a foghorn; and
activating the sound-emitting device upon generation of the signal.
